(19) United States
(12) Patent Application Publication
(10) Pub. No.: US 2005/0137117 A1
(43) Pub. Date: Jun. 23, 2005

(54) Composition containing an optical brightener and a semi-crystalline polymer

(75) Inventor: Yael Charbit, Maisons-Alfort (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: L'OREAL, Paris (FR)

(21) Appl. No.: 11/012,332

(22) Filed: Dec. 16, 2004

Related U.S. Application Data
(60) Provisional application No. 60/537,897, filed on Jan. 22, 2004.

(30) Foreign Application Priority Data
Dec. 22, 2003 (FR) 0351166

(51) Int. Cl. C11D 17/00

(52) U.S. Cl. 510/446

(57) ABSTRACT

The invention relates to a composition containing at least one optical brightener and at least one semi-crystalline polymer that is solid at room temperature and that has a melting point of less than 70° C., the polymer having a) a polymer skeleton and b) at least one crystallizable organic side chain and/or a crystallizable organic block forming part of the polymer skeleton, the polymer having a number-average molecular weight of greater than 2000. The invention also relates to a cosmetic process for lightening and/or bleaching the skin, using the invention composition, and to a makeup process using the invention composition.

### REFERENCE TO PRIOR APPLICATIONS

This application claims priority to U.S. provisional application 60/537,897 filed Jan. 22, 2004, and to French patent application 0351166 filed Dec. 22, 2003, both incorporated herein by reference.

### FIELD OF THE INVENTION

The invention relates to a composition for topical application containing, preferably in a physiologically acceptable medium, at least one optical brightener and at least one particular semi-crystalline polymer. The invention also relates to a cosmetic process for bleaching the skin, and to a process for making up the skin, comprising the topical application of this composition to the skin.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND OF THE INVENTION

It is common for people with lightly coloured or even dark skin to wish to lighten their skin colour, and use, for this purpose, cosmetic compositions containing one or more lightening or bleaching agents.

The substances most commonly used as bleaching agents are hydroquinone and its derivatives, kojic acid and its derivatives, azelaic acid, arbutin and its derivatives, vitamin C and its derivatives (for example magnesium ascorbyl phosphate or ascorbyl glucoside), alone or in combination with other active agents. To obtain an appreciable lightening effect, these various compounds must be used in a large amount and for a long time. However, they act on biological mechanisms at various levels, and are therefore not entirely devoid of adverse effects, which, while possibly being acceptable in the case of short-term use, become disadvantageous when the products are used for a long time and in large amount. Furthermore, the bleaching or lightening effect is generally not observed immediately after applying these compositions containing these bleaching or lightening agents. Finally, these substances are difficult to formulate and demand particular formulation constraints.

It is also known practice to use cosmetic compositions capable of unifying the complexion, and which may give an immediate white appearance, these compositions consisting of powders dispersed in a binder. The powders are generally white or coloured pigments depending on the desired effect and/or fillers of various shapes (lamellar or spherical) depending on the desired effect. The unifying of the complexion is obtained essentially by virtue of the covering power provided by the pigments and fillers. The drawback of such compositions is that the fading-out of the skin defects is provided by the covering power of the compositions. Skin that has thus been made up loses its natural look owing to the lack of transparency of these compositions.

To overcome these drawbacks, patent applications EP-A-0 962 224 or WO-00/71085 propose the use of optical brighteners such as stilbene derivatives, coumarin derivatives, oxazole and benzoxazole derivatives and imidazole derivatives. When optical brighteners are incorporated into cosmetic and/or dermatological compositions, they give a homogeneous, uniform white complexion of natural appearance, these compositions having satisfactory transparency after they have been applied to the skin.

Optical brighteners are optical bleaching agents that are chemical compounds which have fluorescent properties, absorbing in the ultraviolet range (maximum absorption at a wavelength of less than 400 nm) and re-emitting the energy by fluorescence at a wavelength of between 380 nm and 830 nm. An energy emission of between 400 nm and 480 nm results in an emission in the blue region of the visible field, which contributes, when this emission takes place on the skin, towards visually bleaching it.

Cosmetic compositions comprising fluorescent brighteners, also known as optical brighteners, are also known from the French patent application published under the number FR-2 741 261. These agents have the advantage of intensifying radiance and of brightening the colours of the cosmetic compositions comprising them when they are applied to the skin or the hair. Haircare compositions and make-up compositions (mascara, nail varnish, lipstick and powders) are described in particular.

The optical brighteners are generally dispersed directly in the cosmetic formulations under consideration, which may, in certain cases, affect their physicochemical stability, and will do so proportionately more the greater their concentration in the compositions. Moreover, the introduction of these starting materials into compositions for topical use is limited by toxicological constraints. Since the lightening effect is directly linked to the amount of optical brightener used, it decreases when the concentration of optical brightener used is minimized so as to overcome the drawbacks mentioned previously.

### DETAILED DESCRIPTION OF THE PREFERRED EMBODIMENTS

There is thus still a need for cosmetic compositions that are easy to formulate, containing a reduced amount of optical brightener and having an optimum lightening and/or bleaching effect.

The inventor has discovered, surprisingly, that the bleaching and/or lightening effect of optical brighteners is reinforced by the presence of particular semi-crystalline polymers in the composition, which makes it possible to incorporate optical brighteners in smaller amounts into the compositions and thus to solve the problems mentioned previously.

One subject of the invention is thus a composition for topical application to the skin, comprising, for example in a physiologically acceptable medium, at least one optical brightener and at least one semi-crystalline polymer that is solid at room temperature and that has a melting point of less than 70° C., the polymer comprising a) a polymer skeleton and b) at least one crystallizable organic side chain and/or a crystallizable organic block forming part of the polymer skeleton, the polymer having a number-average molecular mass (weight) of greater than 2000.

In the present patent application, the term “room temperature” means a temperature of 25° C.

Semi-Crystalline Polymers

For the purposes of the invention, the term “semi-crystalline polymer” means polymers comprising at least one crystallizable portion, pendent chain or sequence in the skeleton, and at least one amorphous portion in the skeleton, and having a first-order reversible temperature of phase change, in particular of melting (solid-liquid transition). For the purposes of the invention, the term “polymers” means compounds comprising at least 2 repeating units, preferably at least 3 repeating units and more especially at least 10 repeating units. When the crystallizable portion is a sequence of the polymer skeleton, the chemical nature of this crystallizable sequence is different from that of the amorphous sequences; the semi-crystalline polymer is in this case a block polymer, for example of the diblock, triblock or multiblock type.

Advantageously, the semi-crystalline polymer(s) of the composition of the invention has (have) a number-average molecular weight \overline{M}n of greater than or equal to 2 000, preferably ranging, for example, from 2 000 to 800 000, more preferably from 3 000 to 500 000, for example from 4 000 to 150 000 and better still from 4 000 to 99 000.

In one advantageous aspect of the invention, the compositions are in the form of an oil-in-water or water-in-oil emulsion, a triple emulsion or an anhydrous gel. More particularly, the composition is in the form of a water-in-oil emulsion.

In the composition according to the invention, the semi-crystalline polymers are advantageously soluble in the oily phase to at least 0.1% by weight, at a temperature above their melting point. Beyond the crystallizable chains or sequences, the polymer sequences are amorphous. For the purposes of the invention, the expression “crystallizable chain or sequence” means a chain or sequence which, if it was alone, would pass from the amorphous state to the crystalline state, reversibly, depending on whether it is above or below the melting point. For the purposes of the invention, a chain is a group of atoms that is pendent or lateral relative to the polymer skeleton. A sequence is a group of atoms belonging to the skeleton, this group constituting one of the repeating units of the polymer.

Preferably, the polymer skeleton of the semi-crystalline polymers is soluble in the oily phase.

Preferably, the semi-crystalline polymers used in the composition of the invention have a melting point Tm of less than 70° C. (25° C.≦Tm≦70° C.), better still less than or equal to 60° C., ranging for example from 30° C. to 60° C. (30° C.≦Tm≦60° C.), this temperature being at least equal to the temperature of the keratinous support that is to receive the composition according to the invention. When the composition constitutes a nonsolid product and in particular a cream, the melting point Tm is preferably less than 60° C., and better still less than 50° C. (30° C.≦Tm≦50° C.). The melting point may be measured especially by any known method and in particular using a differential scanning calorimeter (DSC).

Preferably, the crystallizable sequences or chains of the semi-crystalline polymers represent at least 30% of the total weight of each polymer and better still at least 40%. The semi-crystalline polymers containing crystallizable sequences used according to the invention are block or multiblock polymers. They may be obtained by polymerization of a monomer containing reactive (or ethylenic) double bonds or by polycondensation. When the polymers of the invention are polymers containing crystallizable side chains, they are advantageously in random form.

Preferably, the semi-crystalline polymers of the invention are of synthetic origin. In addition, they preferably do not comprise a polysaccharide skeleton.

The semi-crystalline polymers that may be used in the invention may be chosen in particular from (i.e., include):
1. block copolymers of polyolefins of controlled crystallization, the monomers of which are described in document EP-A-95 1 897;
2. polycondensates and especially aliphatic or aromatic polyester polycondensates and aliphatic/aromatic copolyesters;
3. polymers (homopolymers or copolymers) bearing at least one crystallizable side chain, and polymers (homopolymers or copolymers) bearing in the skeleton at least one crystallizable sequence, for instance those described in document U.S. Pat. No. 5,156,911;
4. polymers (homopolymers or copolymers) bearing at least one crystallizable side chain containing one (or more) fluoro group(s), as described in document WO-A-01/19333;
5. and mixtures thereof.

In the last two cases (3 and 4), the crystallizable sequence(s) or side chain(s) is(are) hydrophobic.

Crystalline polymers containing crystallizable side chains or bearing in the skeleton at least one crystallizable sequence (case 3 indicated above) are described more particularly hereinbelow.

A) Semi-Crystalline Polymers Containing Crystallizable Side Chains

Mention may be made in particular of those described in documents U.S. Pat. No. 5,156,911 and WO-A-01/19333. They are homopolymers or copolymers comprising from 50% to 100% by weight of units resulting from the polymerization of one or more monomers bearing crystallizable hydrophobic side chain(s). These polymers are of any nature provided that they meet the conditions indicated below with, in particular, the characteristic of being soluble or dispersible in the oily phase, by heating above their melting point Tm. They may result:
from the polymerization, especially free-radical polymerization, of one or more monomers containing reactive or ethylenic double bonds with respect to a polymerization, i.e. a vinyl, (meth)acrylic or allylic group;
from the polycondensation of one or more monomers bearing co-reactive groups (carboxylic acid, sulfonic acid, alcohol, amine or isocyanate), such as, for example, polyesters, polyurethanes, polyethers, polyureas and polyamides.

a) In general, the crystallizable units (chains or sequences) of the semi-crystalline polymers according to the invention are obtained from monomer(s) containing crystallizable sequence(s) or chain(s), used for the manufacture of the semi-crystalline polymers. These polymers are chosen especially from homopolymers and copolymers resulting from the polymerization of at least one monomer containing crystallizable chain(s), which may be represented by the formula X: 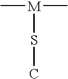
in which M represents an atom of the polymer skeleton, S represents a spacer and C represents a crystallizable group.

The crystallizable chains “—S—C” may be aliphatic or aromatic, and optionally fluorinated or perfluorinated. “S” especially represents a linear or branched or cyclic group (CH₂)ₙ or (CH₂CH₂O)ₙ or (CH₂O), n being an integer ranging from 0 to 22. Preferably, “S” is a linear group. Preferably, “S” and “C” are different.

When the crystallizable chains are aliphatic (alkyl) chains, they comprise at least 11 carbon atoms and not more than 40 carbon atoms and better still not more than 24 carbon atoms. They are especially alkyl chains containing at least 12 carbon atoms, and are preferably alkyl chains containing from 14 to 24 carbon atoms (C₁₄-C₂₄). They may be hydrocarbon-based alkyl chains (carbon and hydrogen atoms) or fluoroalkyl or perfluoroalkyl chains (carbon atoms, fluorine atoms and possibly hydrogen atoms). When they are fluoroalkyl or perfluoroalkyl chains, they comprise at least 11 carbon atoms, at least 6 carbon atoms of which are fluorinated. Monomers having an alkyl chain containing at least 14 carbon atoms provide the resulting polymers with structuring of the fatty phase by crystallization, which is not the case with carbon-based alkyl chains containing less than 14 carbon atoms. Examples of semi-crystalline polymers or copolymers containing crystallizable chain(s) that may be mentioned include those resulting from the polymerization of at least one monomer with a crystallizable chain chosen from saturated C₁₄-C₂₄ alkyl (meth)acrylates (“C₁₄-C₂₄” means that the alkyl group contains from 14 to 24 carbon atoms); C₁₁-C₁₅ perfluoroalkyl (meth)acrylates (alkyl group with 11 to 15 carbon atoms); C₁₄ to C₂₄ N-alkyl(meth)acrylamides with or without a fluorine atom (alkyl group with 14 to 24 carbon atoms); vinyl esters containing C₁₄ to C₂₄ alkyl or perfluoroalkyl chains (alkyl group with 14 to 24 carbon atoms), a perfluoroalkyl chain containing at least 6 fluorine atoms; vinyl ethers containing C₁₄ to C₂₄ alkyl or perfluoroalkyl chains (alkyl group with 14 to 24 carbon atoms), a perfluoroalkyl chain containing at least 6 fluorine atoms; C₁₄ to C₂₄ α-olefins (alkyl group with 14 to 24 carbon atoms) such as, for example, octadecene; C₁₄ to C₂₄ para-alkylstyrenes (alkyl group with 14 to 24 carbon atoms), and mixtures thereof.

For the purposes of the invention, the term “alkyl” means a saturated group especially containing from 8 to 24 carbon atoms (C₈ to C₂₄), except where specifically mentioned, and better still from 14 to 24 carbon atoms (C₁₄ to C₂₄).

When the polymers result from a polycondensation, the hydrocarbon-based and/or fluorinated crystallizable chains as defined above are borne by a monomer that may be a diacid, a diol, a diamine or a diisocyanate.

When the polymers used in the composition of the invention are copolymers, they also contain from 0 to 50% of groups Y or Z resulting from the copolymerization:

α) with Y which is a polar or non-polar monomer or a mixture of the two:
When Y is a polar monomer, it is either a monomer bearing polyoxyalkylenated (especially oxyethylenated and/or oxypropylenated) groups, a hydroxyalkyl (meth)acrylate, for instance hydroxyethyl acrylate, (meth)acrylamide, an N-alkyl(meth)acrylamide, an N,N-dialkyl(meth)acrylamide such as, for example, N,N-diisopropylacrylamide or N-vinylpyrrolidone (NVP), N-vinylcaprolactam, or a monomer bearing at least one carboxylic acid group, for instance (meth)acrylic acids, crotonic acid, itaconic acid, maleic acid or fumaric acid or bearing a carboxylic acid anhydride group, for instance maleic anhydride, and mixtures thereof.
When Y is a non-polar monomer, it may be an ester of the linear, branched or cyclic alkyl (meth)acrylate type, a vinyl ester, an alkyl vinyl ether, an α-olefin, styrene or styrene substituted with an alkyl group containing from 1 to 10 carbon atoms (C₁ to C₁₀), for instance α-methylstyrene, or a macromonomer of the polyorganosiloxane type containing vinylic unsaturation.

β) with Z which is a polar monomer or a mixture of polar monomers, Z having the same definition as the “polar Y” defined above.

Preferably, the semi-crystalline polymers containing a crystallizable side chain are chosen from alkyl (meth)acrylate or alkyl(meth)acrylamide homopolymers with an alkyl group as defined above, and especially of C₁₄-C₂₄; the copolymers of these monomers with a hydrophilic monomer preferably different in nature from (meth)acrylic acid; and mixtures thereof. They may be, for example, copolymers, copolymers of alkyl (meth)acrylate or of alkyl(meth)acrylamide with a C₁₄ to C₂₄ alkyl group, with N-vinylpyrrolidone, hydroxyethyl (meth)acrylate or acrylic acid; or mixtures thereof.

B) Polymers Bearing in the Skeleton at Least One Crystallizable Sequence:

These are again polymers that are soluble or dispersible in the oily phase by heating above their melting point Tm. These polymers are especially block copolymers consisting of at least two sequences of different chemical nature, one of which is crystallizable.

The following may be used in particular:
1) the polymers defined in document U.S. Pat. No. 5,156,911;
2) block copolymers of olefin or of cycloolefin containing a crystallizable chain, for instance those derived from the block polymerization of:
   cyclobutene, cyclohexene, cyclooctene, norbornene (i.e. bicyclo[2.2.1]hept-2-ene), 5-methylnorbornene, 5-ethylnorbornene, 5,6-dimethylnorbornene, 5,5,6-trimethylnorbornene, 5-ethylidenenorbornene, 5-phenylnorbornene, 5-benzylnorbornene, 5-vinylnorbornene, 1,4,5,8-dimethano-1,2,3,4,4a,5,8α-octahydronaphthalene, dicyclopentadiene, or mixtures thereof;
   with ethylene, propylene, 1-butene, 3-methyl-1-butene, 1-hexene, 4-methyl-1-pentene, 1-octene, 1-decene or 1-eicosene, or mixtures thereof These block copolymers may in particular be (ethylene/norbornene) block copolymers and (ethylene/propylene/ethylidenenorbornene) block terpolymers.

Those resulting from the block copolymerization of at least 2 C₂-C₆ and better still C₂-C₁₂ α-olefins, such as those mentioned above and in particular block bipolymers of ethylene and of 1-octene, may also be used.
3) Copolymers containing at least one crystallizable sequence, the rest of the copolymer being amorphous (at room temperature). These copolymers may also have two crystallizable sequences of different chemical nature. The preferred copolymers are those simultaneously containing at room temperature a crystallizable sequence and an amorphous sequence that is both hydrophobic and lipophilic, sequentially distributed; examples that may be mentioned include polymers containing one of the crystallizable sequences below and one of the amorphous sequences below:
Naturally crystallizable sequence: a) polyester, for instance poly(alkylene terephthalate), b) polyolefin, for instance polyethylenes or polypropylenes.
Amorphous and lipophilic sequence, for instance amorphous polyolefins or amorphous copoly(olefins) such as poly(isobutylene), hydrogenated polybutadiene or hydrogenated poly(isoprene).

As examples of such copolymers containing a crystallizable sequence and an amorphous sequence, mention may be made of:
α) poly(ε-caprolactone)-b-poly(butadiene) block copolymers, preferably used in hydrogenated form, such as those described in the article “Melting behavior of poly(-caprolactone)-block-polybutadiene copolymers” by S. Nojima, Macromolecules, 32, 3727-3734 (1999);
β) block or multiblock hydrogenated poly(butylene terephthalate)-b-poly(isoprene) block copolymers, mentioned in the article “Study of morphological and mechanical properties of PP/PBT” by B. Boutevin et al., Polymer Bulletin, 34, 117-123 (1995);
γ) the poly(ethylene)-b-copoly(ethylene/propylene) block copolymers mentioned in the articles “Morphology of semi-crystalline block copolymers of ethylene-(ethylene-alt-propylene)” by P. Rangarajan et al., Macromolecules, 26, 4640-4645 (1993), and “Polymer aggregates with crystalline cores: the system poly(ethylene)-poly(ethylene-propylene)” by P. Richter et al., Macromolecules, 30, 1053-1068 (1997);
δ) the poly(ethylene)-b-poly(ethylethylene) block copolymers mentioned in the general article “Crystallization in block copolymers” by I. W. Hamley, Advances in Polymer Science, vol. 148, 113-137 (1999).

The semi-crystalline polymers in the composition of the invention may be non-crosslinked or partially crosslinked, provided that the degree of crosslinking does not overly harm their dissolution or dispersion in the oily phase by heating above their melting point. This may then be a chemical crosslinking, by reaction with a multifunctional monomer during the polymerization. It may also be a physical crosslinking which may then be due either to the establishment of bonds of hydrogen type or dipolar type between groups borne by the polymer, such as, for example, the dipolar interactions between carboxylate ionomers, these interactions being of small amount and borne by the polymer skeleton; or to a phase separation between the crystallizable sequences and the amorphous sequences borne by the polymer.

Preferably, the semi-crystalline polymers in the composition according to the invention are non-crosslinked.

According to one particular embodiment of the invention, the polymer is chosen from copolymers resulting from the polymerization of at least one monomer containing a crystallizable chain chosen from saturated C₁₄-C₂₄ alkyl (meth)acrylates, C₁₁-C₁₅ perfluoroalkyl (meth)acrylates, C₁₄ to C₂₄ N-alkyl(meth)acrylamides with or without a fluorine atom, vinyl esters containing C₁₄ to C₂₄ alkyl or perfluoroalkyl chains, vinyl ethers containing C₁₄ to C₂₄ alkyl or perfluoralkyl chains, C₁₄ to C₂₄ α-olefins, para-alkylstyrenes with an alkyl group containing from 12 to 24 carbon atoms, with at least one optionally fluorinated C₁ to C₁₀ monocarboxylic acid ester or amide, which may be represented by the following formula: 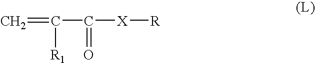
in which R₁ is H or CH₃, R represents an optionally fluorinated C₁-C₁₀ alkyl group and X represents O, NH or NR₂, in which R₂ represents an optionally fluorinated C₁-C₁₀ alkyl group.

According to one more particular embodiment of the invention, the polymer is derived from a monomer containing a crystallizable chain chosen from saturated C₁₄-C₂₂ alkyl(meth)acrylates.

As a specific example of a semi-crystalline polymer that may be used in the composition according to the invention, mention may be made of the Intelimer® products from the company Landec described in the brochure “Intelimer® polymers” and in the patent application U.S.-2001/0018484. These polymers are in solid form at room temperature (25° C.). They bear crystallizable side chains. Mention may be made especially of “Intelimer® IPA 13-1”, which is a polystearyl acrylate with a melting point Tm of 48-49° C., which is an impermeable, non-sticky product that is solid at room temperature.

The semi-crystalline polymers described in Examples 3, 4, 5, 7 and 9 of document U.S. Pat. No. 5,156,911, resulting from the copolymerization of acrylic acid and of a C₅ to C₁₆ alkyl(meth)acrylate having a Tm ranging from 20° C. to 35° C. may also be used, and more particularly those resulting from the copolymerization:
of acrylic acid, of hexadecyl acrylate and of isodecyl acrylate in a 1/16/3 ratio;
of acrylic acid and of pentadecyl acrylate in a 1/19 ratio;
of acrylic acid, of hexadecyl acrylate and of ethyl acrylate in a 2.5/76.5/20 ratio;
of acrylic acid, of hexadecyl acrylate and of methyl acrylate in a 5/85/10 ratio;
of acrylic acid and of polyoctadecyl methacrylate in a 2.5/97.5 ratio.

The polymer “Structure O” sold by the company National Starch, such as the product described in document U.S. Pat. No. 5,736,125, with a Tm of 44° C., and also semi-crystalline polymers containing crystallizable pendent chains comprising fluorinated groups, as described in Examples 1, 4, 6, 7 and 8 of document WO-A-01/19333, may also be used.

The semi-crystalline polymers obtained by copolymerization of stearyl acrylate and of acrylic acid or of NVP, as described in document U.S. Pat. No. 5,519,063 or EP-A-0 550 745, may also be used.

The semi-crystalline polymers obtained by copolymerization of behenyl acrylate and of acrylic acid or of NVP, as described in documents U.S. Pat. No. 5,519,063 and EP-A-0 550 745, may also be used.

According to one particular embodiment of the invention, the semi-crystalline polymers used do not comprise any carboxylic groups.

The polymer(s) used and the amount of this (these) polymer(s) are chosen according to the desired finality of the composition and as a function of the particular application envisaged. In general, the composition of the invention comprises at least one semi-crystalline polymer chosen from semi-crystalline polymers with a melting point ranging from 50 to 70° C. and semi-crystalline polymers with a melting point ranging from 30 to 50° C., and mixtures thereof.

When the composition of the invention is in the form of a cream, i.e. a soft product as opposed to a solid product, the polymer used may especially be chosen from those described in Examples 1 and 2 of document U.S. Pat. No. 5,519,063 or EP-A-0 550 745, having a melting point of 40° C. and 38° C., respectively.

When the composition is solid, according to one preferred embodiment of the invention, the composition comprises at least one semi-crystalline polymer having a Tm ranging from 50 to 70° C. According to one more particular embodiment of the invention, a solid composition comprises at least 2 semi-crystalline polymers, i.e. at least one semi-crystalline polymer having a Tm ranging from 50° C. to 70° C. and at least one semi-crystalline polymer having a Tm ranging from 25° C. to 50° C. and better still from 30° C. to 50° C. The total amount of semi-crystalline polymer is then chosen according to the desired hardness of the composition and as a function of the particular application envisaged. This hardness is such that the composition is self-supporting, i.e. it supports itself, remaining in its solid form (for example as a tube) and it does not collapse under its own weight as do creams or liquids, and it can be easily disintegrated to form a satisfactory deposit on the skin and the lips. The hardness of the sticks obtained is measured at 20° C. using a DFGHS 2 tensile testing machine from the company Indelco-Chatillon travelling at a speed of 100 mm/minute. This hardness is expressed as the shear force (expressed in gram-force, gf) required to break a stick 12.7 mm in diameter under these conditions. In the present patent application, the shear force of the composition preferably ranges from 100 to 350 gf, better still from 120 to 250 gf and even better still from 150to220gf.

In practice, the total amount of semi-crystalline polymer preferably represents from 0.1% to 50% by weight relative to the total weight of the composition. When the composition is a cream, this amount preferably ranges from 0.5% to 20% by weight and better still from 1% to 10% by weight of active material relative to the total weight of the composition. When the composition is a solid, this amount preferably ranges from 1% to 40% by weight and better still from 5% to 20% by weight of active material relative to the total weight of the composition, this amount preferably being at least 5% by weight of active material relative to the total weight of the composition. In the case of a stick, advantageously, the weight ratio of semi-crystalline polymer relative to the oily phase is from 0.20 to 0.60 and better still from 0.25 to 0.50, to obtain a hard stick that disintegrates on contact with the skin or the lips and in particular with a hardness ranging from 100 to 350 gf.

In a preferred embodiment, the amount of invention polymer(s) is that amount that reinforces the bleaching and/or lightening effect of optical brighteners, which makes it possible to incorporate optical brighteners in smaller amounts into the compositions. Such amounts are determinable by one of ordinary skill without undue work, using the above guidance and by routine experimentation, for example by varying the amounts of polymer and/or brightener and testing the resulting composition, in view of this disclosure. Such amounts may be referred to as optical brightener reinforcing effective amounts, which amounts provide a bleaching and/or lightening effect that is at least the same as a bleaching and/or lightening effect obtained with more optical brightener and no polymer. When comparing compositions containing an invention optical brightener with and without an invention polymer, preferred increases in bleaching and/or lightening effect (e.g., brightening efficacy) include 1%, 3%, 5%, 10%, 15% and more, such as 35%, 50%, etc.

Optical brighteners:

In the context of the present invention, the term “optical brightener” means a compound that absorbs in the UVA range between 300 and 390 nm and re-emits between 400 and 525 nm.

It is possible, in particular, to use an optical brightener chosen from the group consisting of:
1) bis(benzoxazol-2-yl) compounds of formula (1): 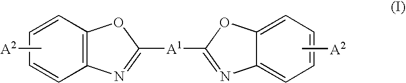
   in which A¹ is an aromatic, heterocyclic or alkylene group and A² is a hydrogen atom or an alkyl group;
2) coumarins of formula (II): 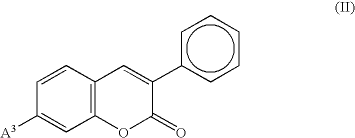
   in which A³ is a heterocyclic group;
3) bis(styryl)biphenyl compounds of formula (III): 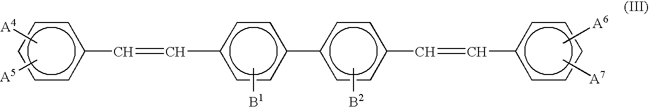
   in which A⁴, A⁵, A⁶, A⁷, B¹ and B², which may be identical or different, independently represent a hydrogen atom, —SO₃Na or an alkyl group; and
4) triazine-stilbene derivatives of formula (IV): 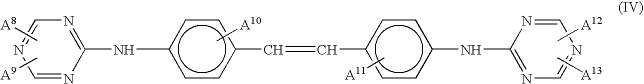
   in which A⁸, A⁹, A¹² and A¹³ independently represent a hydrogen atom, an —SO₃Na group or a phenylamino, dialkylamino or morpholino group and A¹⁰ and A¹¹ independently represent a hydrogen atom or —SO₃Na.

In the formulae given above, the aromatic groups used can be groups comprising one or more benzene rings, for example phenyl, biphenyl or substituted phenyl groups or aromatic groups formed from polycyclic aromatic hydrocarbons, such as naphthyl, phenanthryl, anthracenyl, fluoranthenyl, etc. groups.

The heterocyclic groups are saturated or unsaturated hydrocarbon-based groups comprising one or more hetero atoms such as O, N and S. Examples of heterocyclic groups which may be mentioned are thienyl, furyl, pyranyl, isobenzofuryl, isobenzothienyl, pyrrolyl, pyridyl and pyrazolyl groups.

The alkylene groups used may be linear or branched and may contain from 3 to 16 carbon atoms.

The alkyl groups which can be used are linear or branched groups, preferably containing from 1 to 16 carbon atoms. The tert-butyl group is used in particular.

In one preferred aspect of the invention, the optical brighteners are chosen from:
the stilbene derivatives of formula (IV) above, and in particular sodium 4,4′-bis[(4,6-dianilino-1,3,5-triazin-2-yl)amino]stilbene-2,2′-disulfonate sold by the company Ciba Specialités Chimiques under the name Tinopal SOP;
the benzoxazole derivatives of formula (I) above, and in particular 2,5-thiophenediylbis-(5-tert-butyl-1,3-benzoxazole) sold by the company Ciba Specialités Chimiques under the name Uvitex OB; and
the bis(styryl)biphenyl derivatives of formula (III) above, and in particular sodium distyryl-4,4′-biphenyldisulfonate sold by the company Ciba Specialités Chimiques under the name Tinopal CBS-X.

In the compositions according to the invention, the optical brightener preferably represents from 0.001% to 10% by weight relative to the total weight of the composition, more preferably from 0.01% to 5% and more particularly from 0.1% to 3% by weight relative to the total weight of the composition.

The compositions used according to the invention may especially constitute cosmetic compositions. For such an application, they contain a physiologically acceptable medium. The term “physiologically acceptable medium” means herein a medium that is compatible with the skin, and possibly the lips, the scalp, the eyelashes, the eyes and/or the hair. This physiologically acceptable medium may more particularly consist of a physiologically acceptable organic solvent and possibly water. The organic solvent may be chosen, for example, from lower alcohols containing from 1 to 4 carbon atoms, for instance ethanol, isopropanol, propanol or butanol; polyethylene glycols containing from 6 to 80 ethylene oxide units; polyols, for instance propylene glycol, isoprene glycol, butylene glycol, glycerol or sorbitol. The physiologically acceptable medium of the composition according to the invention has a pH that is compatible with the skin, preferably ranging from 3 to 8 and better still from 5 to 7.

The compositions according to the present invention preferably comprise at least one oily phase. This oily phase may be present in an amount ranging, for example, from 10% to 95% by weight, preferably from 10% to 80% by weight, better still from 15% to 70% by weight and even better still from 20% to 60% by weight relative to the total weight of the composition.

This oily phase contains at least one oil, especially a cosmetic oil, and it may contain several oils and optionally one or more other fatty substances.

As oils that may be used in the invention, mention may be made of mineral oils (liquid petroleum jelly), plant oils (liquid fraction of shea butter, sunflower oil or apricot kernel oil), animal oils (perhydrosqualene), synthetic oils (hydrogenated polyisobutene, isostearyl neopentanoate or isopropyl myristate), non-volatile or volatile silicone oils (cyclomethicones such as cyclopentasiloxane and cyclohexasiloxane) and fluoro oils (perfluoropolyethers). Fatty substances that may also be used include fatty alcohols, fatty acids and waxes. The oily phase of the emulsion may also contain gums such as silicone gums, resins and waxes.

In a known manner, the compositions of the invention may also contain adjuvants that are known in cosmetics or dermatology, such as hydrophilic or lipophilic gelling agents, hydrophilic or lipophilic active agents, preserving agents, antioxidants, solvents, fragrances, fillers, sunscreens, bactericides, odour absorbers, dyestuffs and salts. The amounts of these various adjuvants are those used in the field under consideration, for example from 0.01% to 20% of the total weight of the composition and preferably from 0.01% to 10% of the total weight of the composition. Depending on their nature, these adjuvants may be introduced into a fatty phase, into an aqueous phase and/or into lipid spherules.

As active agents, the composition may contain active agents such as those used in cosmetics, chosen, for example, from desquamating agents, moisturizers, depigmenting agents, pro-pigmenting agents, anti-glycation agents, NO-synthase inhibitors, 5α-reductase inhibitors, lysyl and/or prolyl hydroxylase inhibitors, agents for stimulating the synthesis of dermal or epidermal macromolecules and/or for preventing their degradation, agents for stimulating fibroblast or keratinocyte proliferation and/or keratinocyte differentiation, muscle relaxants, antimicrobial agents, tensioning agents, antipollution agents or free-radical scavengers, anti-inflammatory agents, lipolytic active agents or agents with a direct or indirect favourable activity on reducing adipose tissue, agents acting on the capillary circulation, and agents acting on the energy metabolism of cells.

Advantageously, the composition according to the invention comprising at least one optical brightener and at least one semi-crystalline polymer as defined above also contains at least one second skin-bleaching agent not belonging to the family of optical brighteners. The second skin-bleaching agent is preferably a melanogenesis inhibitor.

The bleaching agents that may be incorporated into the composition according to the present invention comprise, for example, the following compounds: kojic acid; ellagic acid; arbutin and its derivatives, such as those described in patent applications EP-895 779 and EP-524 109; hydroquinone; aminophenol derivatives, such as those described in patent applications WO 99/10318 and WO 99/32077, and in particular N-cholesteryloxycarbonyl-para-aminophenol and N-ethyloxycarbonyl-para-aminophenol; iminophenol derivatives, in particular those described in patent application WO 99/22707; L-2-oxothiazolidine-4-carboxylic acid or procysteine, and also salts and esters thereof; calcium D-pantethine sulfonate, and ascorbic acid and its derivatives, especially ascorbyl glucoside; and plant extracts, in particular extracts of liquorice, of mulberry, of skullcap and of Bacopa monnieri, without this list being limiting.

According to another embodiment of the invention, the compositions used may also comprise at least one organic photoprotective agent and/or at least one mineral photoprotective agent that is active in the UVA and/or UVB range (absorbers), which are water-soluble or liposoluble, or even insoluble in the cosmetic solvents commonly used.

The preferred organic photoprotective agents are chosen from ethylhexyl salicylate, ethylhexyl methoxycinnamate, octocrylene, phenylbenzimidazolesulfonic acid, benzophenone-3, benzophenone-4, benzophenone-5, 4-methylbenzylidenecamphor, terephthalylidenedicamphorsulfonic acid, disodium phenyldibenzimidazoletetrasulfonate, 2,4,6-tris(diisobutyl 4′-aminobenzalmalonate)-s-triazine, anisotriazine, ethylhexyl triazone, diethylhexylbutamidotriazone, methylenebis(benzotriazolyl)tetramethylbutylphenol and drometrizole trisiloxane, and mixtures thereof.

The preferred mineral photoprotective agents are chosen from pigments or nanopigments (mean size of the primary particles: generally between 5 nm and 100 nm and preferably between 10 nm and 50 nm) of coated or uncoated metal oxides, for instance nanopigments of titanium oxide (amorphous or crystallized in rutile and/or anatase form), iron oxide, zinc oxide, zirconium oxide or cerium oxide, which are all UV-photoprotective agents that are well known per se. Moreover, standard coating agents are alumina and/or aluminium stearate. Such coated or uncoated metal oxide nanopigments are described in particular in patent applications EP 518 772and EP 518 773.

The photoprotective agents are generally present in the compositions according to the invention in proportions ranging from 0.1% to 20% by weight relative to the total weight of the composition, and preferably ranging from 0.2% to 15% by weight relative to the total weight of the composition.

The compositions used according to the invention may be more or less fluid and may have the appearance of a white or coloured cream, an ointment, a balm, a milk, a serum, a paste or a mousse. They may optionally be applied to the skin in the form of an aerosol. They may also be in solid form, for example in the form of a stick.

The use of the compositions according to the invention finds an application more specifically in the cosmetics field. Thus, the present invention also relates to a cosmetic process for lightening and/or bleaching the skin, comprising the topical application to the skin of a composition according to the invention as defined above. This cosmetic process will be intended more particularly for immediate lightening and/or bleaching of the skin. Naturally, a lightening and/or bleaching-effective amount of compositon is preferably applied.

The invention also relates to a makeup process comprising at least one step of applying a cosmetic composition according to the invention as defined above.

Another aspect of the invention relates to the use of a semi-crystalline polymer as defined above to reinforce the bleaching effect of optical brighteners.

The examples that follow serve to illustrate the invention without, however, being limiting in nature. Depending on the case, the compounds are cited as chemical names or as CTFA names (International Cosmetic Ingredient Dictionary and Handbook).

### EXAMPLE 1

### Water/Oil Emulsions

| | | Composition 1 | Composition 2 |
|---|---|---|---|
| Phase | Ingredient (INCI name) | Content (%) | Content (%) |
| A1 | CETYL PEG/PPG-10/1 | 1.5 | 1.5 |
| | DIMETHICONE | | |
| | POLYGLYCERYL-4 | 0.5 | 0.5 |
| | ISOSTEARATE | | |
| | ISOHEXADECANE | 15.5 | 15.5 |
| | PROPYLPARABEN | 0.1 | 0.1 |
| | POLY C10-30 ALKYL | 1.275 | / |
| | ACRYLATE⁽¹⁾ | | |
| A2 | CYCLOHEXASILOXANE | 8.725 | 10 |
| | ACRYLATES COPOLYMER | 1 | 1 |
| A3 | FRAGRANCE | 0.1 | 0.1 |
| B | GLYCEROL | 5 | 5 |
| | METHYLPARABEN | 0.2 | 0.2 |
| | MAGNESIUM SULFATE | 0.7 | 0.7 |
| | WATER | 59.7 | 59.7 |
| | DISODIUM | 0.4 | 0.4 |
| | DISTYRYLBIPHENYL | | |
| | DISULFONATE⁽²⁾ | | |
| C | IMIDAZOLIDINYL UREA | 0.3 | 0.3 |
| | WATER | 2 | 2 |
| D | ALUMINUM STARCH | 3 | 3 |
| | OCTENYLSUCCINATE | | |

⁽¹⁾Semi-crystalline polymer sold by the company Landec under the name Intelimer ® IPA 13-1.
⁽²⁾Optical brightener sold by the company Ciba under the reference Tinopal CBS-X

Procedure:

Phase B was homogenized at 85° C. with a magnetic stirrer. Phase A1 was homogenized on a water bath at 70° C. Phase A2 was introduced into phase A1 at about 65-70° C. Phase A3 was then added to A1+A2. The emulsion was then prepared at between 60 and 70° C. using a Moritz blender, with vigorous stirring, by pouring B into A1+A2+A3. Next, at about 45° C., phase C was introduced, and finally phase D, and the mixture was cooled to room temperature. Two compositions were thus obtained: composition 1 according to the invention, and the comparative composition 2 which contains no semi-crystalline polymer according to the invention.

### EXAMPLE 2

### Oil/Water Emulsions

| | | | Composi- |
|---|---|---|---|
| | | Composition | tion 4 |
| | | 3 | Content |
| Phase | Ingredient (INCI name) | Content (%) | (%) |
| A | STEARYL ALCOHOL | 3 | 3 |
| | STEARIC ACID | 1.5 | 1.5 |
| | PRUNUS ARMENIACA (APRICOT) | 6 | 6 |
| | KERNEL OIL (and) ORYZA | | |
| | SATIVA (RICE) BRAN OIL (and) | | |
| | OLEA EUROPAEA (OLIVE) FRUIT | | |
| | OIL (and) PERSEA GRATISSIMA | | |
| | (AVOCADO) OIL | | |
| | PETROLATUM | / | 4 |
| | POLY C10-30 ALKYL ACRYLATE⁽¹⁾ | 6 | / |
| | SQUALANE | 13 | 13 |
| | MYRISTYL MYRISTATE | / | 2 |
| | PROPYLPARABEN | 0.1 | 0.1 |
| | FRAGRANCE | 0.05 | 0.05 |
| B | GLYCEROL | 7 | 7 |
| | SUCROSE STEARATE | 3.5 | 3.5 |
| | METHYLPARABEN | 0.2 | 0.2 |
| | WATER | 49.7 | 49.7 |
| | DISODIUM DISTYRYLBIPHENYL | 0.4 | 0.4 |
| | DISULFONATE⁽²⁾ | | |
| C | XANTHAN GUM | 0.25 | 0.25 |
| | SQUALANE | 2 | 2 |
| D | POLYACRYLAMIDE (and) C13-14 | 1 | 1 |
| | ISOPARAFFIN (and) LAURETH-7 | | |
| E | DIAZOLIDINYL UREA | 0.3 | 0.3 |
| | WATER | 3 | 3 |
| F | ALUMINUM STARCH | 3 | 3 |
| | OCTENYLSUCCINATE | | |

⁽¹⁾Semi-crystalline polymer sold by the company Landec under the name Intelimer ® IPA 13-1.
⁽²⁾Optical brightener sold by the company Ciba under the reference Tinopal CBS-X

Procedure
Composition 3:

Phase A was stirred at 60° C. for 30 minutes, and phase B was stirred at 85° C. Phase A was then poured into phase B at 60° C., and phases C and B were then added at this temperature. The mixture was then cooled on a water bath and phases E and F were added at 30° C., to give composition 3 according to the invention.
Composition 4:

Phase A was heated to 75° C. on a water bath. Phase B was heated to 85° C. and maintained under magnetic stirring. Phase A was then added to phase B at 75° C. with stirring, and phases C and D were then incorporated. Phases E and F were incorporated at room temperature, to give the comparative composition 4 which contains no semi-crystalline polymer according to the invention.

### EXAMPLE 3

### in vitro Measurement of the Brightening Efficiency

The aim of this test was to measure the ΔE value of the sample using a spectrocolorimeter. This ΔE value reflects the difference in colour observed before and after exposure to UV radiation (UVB +visible). The higher the ΔE value, the better the brightening efficacy found in vivo on a panel of women.

Protocol:

The formulation is spread to a thickness of 50 microns onto a contrast card. The spectra magic CM 3700d series spectrocolorimeter is calibrated.

A measurement of the L, a and b values on the sample not subjected to UV excitation is then taken. Next, the sample is subjected to UV excitation for 2 minutes, followed by taking a new measurement of the L, a and b values.
L=lightness of the sample (L₂, after UV excitation; L₁ before UV excitation)
a=green/red axis (a₂, after UV excitation; a₁, before UV excitation),
b=yellow/blue axis (b₂, after UV excitation; b₁, before UV excitation).

The data are then analysed by computer to obtain the ΔE.

As a reminder, the arithmetic expression of ΔE is such that:
ΔE=[(a₂−a₁)²+(L₂−L₁)² +(b₂−b₁)²]0.5

Results of the Measurements:

The table below shows the results of the measurements taken on compositions 1, 2, 3 and 4.

| Test composition | ΔE value |
|---|---|
| Composition 1 | 5.7 |
| Comparative composition 2 | 3.7 |
| Composition 3 | 10.35 |
| Comparative composition 4 | 10.2 |

These results thus show that the brightening efficacy is improved in the presence of semi-crystalline polymer according to the invention, this improvement being more substantial in a water/oil support.

The above written description of the invention provides a manner and process of making and using it such that any person skilled in this art is enabled to make and use the same, this enablement being provided in particular for the subject matter of the appended claims, which make up a part of the original description and including a composition comprising at least one optical brightener and at least one semi-crystalline polymer that is solid at room temperature and that has a melting point of less than 70° C., the polymer comprising a) a polymer skeleton and b) at least one crystallizable organic side chain and/or a crystallizable organic block forming part of the polymer skeleton, the polymer having a number-average molecular weight of greater than 2000. Preferred embodiments of the invention similarly fully described and enabled include invention compositions comprising an optical brightener reinforcing effective amount of said at least one semi-crystalline polymer.

As used above, the phrases “selected from the group consisting of,” “chosen from,” and the like include mixtures of the specified materials.

All references, patents, applications, tests, standards, documents, publications, brochures, texts, articles, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A composition comprising at least one optical brightener and at least one semi-crystalline polymer that is solid at room temperature and that has a melting point of less than 70° C., the polymer comprising a) a polymer skeleton and b) at least one crystallizable organic side chain and/or a crystallizable organic block forming part of the polymer skeleton, the polymer having a number-average molecular weight of greater than 2000.

2. The composition according to claim 1, wherein the polymer has a number-average molecular weight of from 3000 to 500 000.

3. The composition according to claim 1, wherein the compositon further comprises an oily phase and the polymer is soluble in the oily phase to at least 0.1% by weight at a temperature above its melting point.

4. The composition according to claim 1, wherein the polymer has a melting point Tm such that 30° C.≦Tm≦60° C.

5. The composition according to claim 1, wherein the polymer is selected from the group consisting of:
block copolymers of polyolefins of controlled crystallization,
aliphatic or aromatic polyester polycondensates and aliphatic/aromatic copolyesters, homopolymers or copolymers bearing at least one crystallizable side chain, and homopolymers or copolymers bearing in the skeleton at least one crystallizable sequence,
homopolymers or copolymers bearing at least one crystallizable side chain containing one (or more) fluoro group(s),
and mixtures thereof.

6. The composition according to claim 1, wherein the polymer is selected from the group consisting of homopolymers and copolymers comprising from 50% to 100% by weight of units resulting from the polymerization of one or more monomers bearing crystallizable hydrophobic side chain(s), and mixtures thereof.

7. The composition according to claim 1, wherein the polymer is selected from the group consisting of homopolymers and copolymers resulting from the polymerization of at least one monomer containing crystallizable chain(s) of formula X: 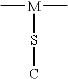
in which M represents an atom of the polymer skeleton, S represents a spacer and C represents a crystallizable group, and mixtures thereof.

8. The composition according to claim 1, wherein the polymer is selected from the group consisting of homopolymers, copolymers and mixtures thereof resulting from the polymerization of at least one monomer with a crystallizable chain selected from the group consisting of saturated C₁₄-C₂₄ alkyl(meth)acrylates, C₁₁-C₁₅ perfluoroalkyl(meth)acrylates, C₁₄ to C₂₄ N-alkyl(meth)acrylamides with or without a fluorine atom, vinyl esters containing C₁₄ to C₂₄ alkyl or perfluoroalkyl chains, vinyl ethers containing C₁₄ to C₂₄ alkyl or perfluoroalkyl chains, C₁₄ to C₂₄ α-olefins; para-alkylstyrenes with an alkyl group containing from 12 to 24 carbon atoms, and mixtures thereof.

9. The composition according to claim 1, comprising a copolymer resulting from the polymerization of at least one monomer with a crystallizable chain selected from the group consisting of saturated C₁₄-C₂₄ alkyl (meth)acrylates, C₁₁-C₁₅ perfluoroalkyl (meth)acrylates, C₁₄ to C₂₄ N-alkyl(meth)acrylamides with or without a fluorine atom, vinyl esters containing C₁₄ to C₂₄ alkyl or perfluoroalkyl chains, vinyl ethers containing C₁₄ to C₂₄ alkyl or perfluoroalkyl chains, C₁₄ to C₂₄ α-olefins, para-alkylstyrenes with an alkyl group containing from 12 to 24 carbon atoms, with at least one optionally fluorinated C₁ to C₁₀ monocarboxylic acid ester or amide, and mixtures thereof.

10. The composition according to claim 1, wherein the polymer is selected from the group consisting of C₁₄ to C₂₄ alkyl(meth)acrylate or alkyl(meth)acrylamide homopolymers; copolymers of these monomers with a hydrophilic monomer; and mixtures thereof.

11. The composition according to claim 1, wherein the polymer is selected from the group consisting of copolymers of alkyl(meth)acrylate or of alkyl(meth)acrylamide with a C₁₄ to C₂₄ alkyl group, with N-vinylpyrrolidone, hydroxyethyl(meth)acrylate or acrylic acid; and mixtures thereof.

12. The composition according to claim 1, comprising a polymer derived from a monomer with a saturated C₁₄ to C₂₄ alkyl(meth)acrylate crystallizable chain.

13. The composition according to claim 1, wherein it comprises at least one semi-crystalline polymer elected from the group consisting of semi-crystalline polymers with a melting point ranging from 50 to 70° C., semi-crystalline polymers with a melting point ranging from 30 to 50° C., and mixtures thereof.

14. The composition according to claim 1, wherein the semi-crystalline polymer is a polystearyl acrylate with a melting point Tm of 48-49° C.

15. The composition according to claim 1, wherein the polymer represents from 0.1% to 50% by weight relative to the total weight of the composition.

16. The composition according to claim 1, wherein the at least one optical brightener absorbs in the UVA range between 300 and 390 nm and re-emits between 400 and 525 nm.

17. The composition according to claim 1, wherein the optical brightener is selected from the group consisting of:
1) bis(benzoxazol-2-yl) compounds of formula (I): 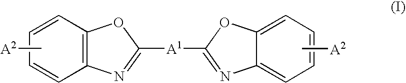
in which A₁ is an aromatic, heterocyclic or alkylene group and A² is a hydrogen atom or an alkyl group;
2) coumarins of formula (II): 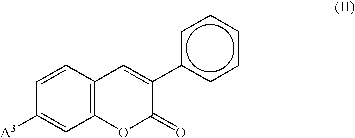
in which A³ is a heterocyclic group;
3) bis(styryl)biphenyl compounds of formula (III): 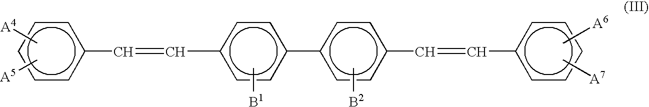
in which A⁴, A⁵, A⁶, A⁷, B¹ and B², which may be identical or different, independently represent a hydrogen atom, —SO₃Na or an alkyl group; and
4) triazine-stilbene derivatives of formula (IV): 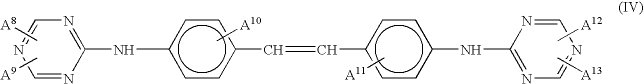
in which A⁸, A⁹, A¹² and A¹³ independently represent a hydrogen atom, an —SO₃Na group or a phenylamino, dialkylamino or morpholino group and A¹⁰ and A¹¹ independently represent a hydrogen atom or —SO₃Na, and
5) mixtures thereof.

18. The composition according to claim 17, wherein the composition comprises sodium 4,4′-bis[(4,6-dianilino-1,3,5-triazin-2-yl)amino]stilbene-2,2′-disulfonate.

19. The composition according to claim 17, wherein the composition comprises 2,5-thiophenediylbis(5-tert-butyl-1,3-benzoxazole).

20. The composition according to claim 17, wherein the composition comprises sodium distyryl-4,4′-biphenyldisulfonate.

21. The composition according to claim 1, wherein the optical brightener represents from 0.001% to 10% by weight relative to the total weight of the composition.

22. The composition according to claim 21, wherein the optical brightener represents from 0.01% to 5% by weight relative to the total weight of the composition.

23. The composition according to claim 1, wherein said compositon is in the form of a water-in-oil emulsion.

24. The composition according to claim 1, further comprising at least one active agent selected from the group consisting of desquamating agents, moisturizers, depigmenting agents, pro-pigmenting agents, anti-glycation agents, NO-synthase inhibitors, 5α-reductase inhibitors, lysyl and/or prolyl hydroxylase inhibitors, agents for stimulating the synthesis of dermal or epidermal macromolecules and/or for preventing their degradation, agents for stimulating fibroblast or keratinocyte proliferation and/or keratinocyte differentiation, muscle relaxants, antimicrobial agents, tensioning agents, antipollution agents or free-radical scavengers, anti-inflammatory agents, lipolytic active agents or agents with a direct or indirect favourable activity on reducing adipose tissue, agents acting on the capillary circulation, agents acting on the energy metabolism of cells, and mixtures thereof.

25. The composition according to claim 1, further comprising at least one skin bleaching agent that is not an optical brightener.

26. The composition according to claim 1, further comprising at least one organic photo protective agent and/or at least one mineral photo protective agent that is (are) active in the UVA and/or UVB range (absorbers).

27. The composition according to claim 1, comprising an optical brightener reinforcing effective amount of said at least one polymer.

28. A process for lightening and/or bleaching the skin, comprising topically applying to the skin a composition as claimed in claim 1.

29. Cosmetic process according to claim 28, wherein said process is for immediate lightening and/or bleaching of the skin.
